(19) United States
(12) Patent Application Publication
(10) Pub. No.: US 2025/0282276 A1
(43) Pub. Date: Sep. 11, 2025

(54) SPACE ENLARGEMENT FOR A RECREATIONAL VEHICLE AND RECREATIONAL VEHICLE THEREOF

(71) Applicant: Thor Tech, Inc., Elkhart, IN (US)

(72) Inventors: Marcus Metzler, Bad Waldsee (DE); Günter Dorn, Schlier (DE)

(21) Appl. No.: 19/069,725

(22) Filed: Mar. 4, 2025

(30) Foreign Application Priority Data
Mar. 5, 2024 (DE) 10 2024 124 550.6

(51) Int. Cl. B60P 3/34

(52) U.S. Cl. CPC B60P 3/343

(57) ABSTRACT

Space enlargement for a recreational vehicle, comprising a roof element which is arranged or arrangeable on a roof or wall of a recreational vehicle and can be transferred from a closed position to an open position, wherein in the open position a spatial volume is formed on the inside of the roof element of the recreational vehicle, at least one side wall which delimits the spatial volume to the outside in the open position, wherein the at least one side wall has, at least in parts thereof, a layer made of a self-expanding material which is at least partially expanded in the open position, wherein the roof element and/or the at least one side wall are designed such that, when the roof element is transferred from the open position to the closed position, a force acts on the self-expanding material which compresses the self-expanding material.

The invention relates to a space enlargement for a recreational vehicle, and to a recreational vehicle having a space enlargement.

In the prior art, an extension or enlargement of the living space of recreational vehicles, in particular motorhomes or camper trailers or the like, by means of pop-up roofs, elevating roofs, sleeping roofs, or slide-out solutions or the like is known. In the scope of this invention, these pop-up roofs, elevating roofs, sleeping roofs, slide-outs or similar structures used to extend or enlarge the living space are summarized as space enlargements. The extension of the living space can be used, for example, to create sleeping spaces or to generate standing height. Typically, a roof element, in particular a roof shell, is lifted by means of a kinematic system, for example supported by gas pressure dampers and/or by an electric drive. Side walls are formed, for example, by a fabric bellows that stretches when the pop-up roof or elevating roof is in the popped-up state and forms a separation to the outside. There are also pop-up roofs or elevating roofs with inflatable side walls or with solid side walls.

The disadvantage of a fabric bellows is that it has a rather low heat-insulating and sound-insulating effect. Inflatable side walls have the disadvantage that a pump, blower, compressor or the like is needed to inflate the side walls. In addition, a permanent, preferably constant, pressure must usually be provided in the popped-up state. Also, the volume of inflatable side walls is often dependent on temperature differences, which reduce or increase the volume, so in many cases electronics or a user must compensate for this. Solid walls, on the other hand, have the disadvantage that they are usually difficult to seal.

It is therefore the object of the present invention to provide a space enlargement for a recreational vehicle, which can allow improvements with regard to the above-mentioned disadvantages. In particular, it would be desirable if the space enlargement had an improved heat-insulating and/or sound-insulating effect. It would also be desirable if the space enlargement could be manufactured and/or operated cost-effectively and easily. It would also be desirable to require as few additional components as possible, such as pumps.

At least one of these objects is achieved by a space enlargement according to claim 1 and a recreational vehicle according to claim 10. Further features, advantages and embodiments emerge from the dependent claims, the description and the figures.

According to the invention, a space enlargement for a recreational vehicle is provided, comprising a roof or wall element which is arranged or arrangeable on a roof or wall of a recreational vehicle and can be transferred from a closed position to an open position, wherein in the open position a spatial volume is formed on the inside of the roof or wall element. The spatial volume can in particular be connected or is connectable to an interior of the recreational vehicle. Furthermore, the space enlargement comprises at least one side wall which delimits the spatial volume to the outside in the open position, wherein the at least one side wall has at least in parts thereof a layer of a self-expanding material which is at least partially expanded in the open position. The roof or wall element and/or the at least one side wall are designed such that, when the roof or wall element is transferred from the open position to the closed position, a force acts on the self-expanding material which compresses the self-expanding material.

Advantageously, the self-expanding material means that no compressor, pump, blower or similar is needed to fill the side walls with air, for example. However, particularly good insulation can be achieved by self-expanding the self-expanding material. Advantageously, it may also be relatively easy to retrofit existing pop-up roofs, which for example have a fabric bellows, with the solution according to the invention. Due to the self-expanding properties, the side walls can be designed to be particularly flexible. For example, they can be made smaller for transport or storage. Advantageously, the installation space requirement can also be reduced, and at the same time the side wall can have heat and sound insulating properties. Flexible adaptation to different technical or design requirements is particularly easy. Particularly good resistance to mold formation can also be achieved.

In the scope of this invention, the term “space enlargement” is generally understood to mean a device that enlarges the space, in particular living space, of a recreational vehicle and/or adds an additional spatial volume. If the space enlargement occurs upwards, it can also be referred to as roof space enlargement within the scope of this invention. However, the space enlargement can also take place to the side, in which case it comprises a wall element in particular. The wall element can, for example, be arranged on a side wall of the vehicle and moved outwards to form a “bay window.” This is also called a “slide-out.” However, the space enlargement can also be a pop-up roof, an elevating roof, a high-elevating roof, a folding roof, a sleeping roof, a roof tent, a temporary living space or the like.

The spatial volume can be connected or is connectable to an interior of the recreational vehicle. The interior preferably comprises a living area of the recreational vehicle. The spatial volume can optionally be directly adjacent to the interior, in particular without separation. The closed position can in particular be a driving position, i.e., a position which the roof or wall element assumes during driving in order not to increase the height and/or width of the vehicle. When stationary, the wall or roof element can then be moved to the open position, in which the vehicle is wider and/or higher, to create more living space inside the vehicle.

According to one embodiment, the space enlargement comprises a roof element. The roof element can be arranged or arrangeable on a roof of the recreational vehicle and/or on a roof of a living and/or recreational area of the recreational vehicle. The roof can, for example, have access to the spatial volume, e.g., in the form of a hatch in the roof of the recreational vehicle. In particular, the roof element can be transferred from a lower, closed position to a popped-up, open position. The lower position can in particular be a driving position. The popped-up position can in particular be a living and/or sleeping position. It may be provided that the closed position is used when the recreational vehicle is travelling and the open position is used when the recreational vehicle is parked, in particular to allow more space for staying in the recreational vehicle. The spatial volume can be intended for a living room and/or bedroom. For example, to form a floor of the living room and/or bedroom, a lower shell can be provided in the spatial volume, which is placed and/or can be placed on a roof of the recreational vehicle and into which a mattress can be inserted. The roof element can be arranged on or above the lower shell. The transfer to the open position can be provided by means of a lifting mechanism. The transfer to the open position can be automated or manual. For example, the space enlargement may comprise a lifting mechanism by which the roof element can be moved from the closed position to the open position. The lifting mechanism can, for example, be based on a scissor mechanism and/or comprise at least one scissor element. Preferably, a lifting mechanism is provided on each of the two sides of the space enlargement. For example, the lifting mechanism can be operated by an actuator. Alternatively, the space enlargement can be designed to be set up by hand. Optionally, an assistance mechanism, e.g., comprising at least one gas pressure spring, preferably at least two gas pressure springs, can be provided, which is designed to facilitate the pop-up operation and to hold the roof element in the open position. The transfer to the closed position can be automated or manual. For example, a grip element can be provided for pulling down the roof element. The grip element can be, for example, a cord or a handle.

The spatial volume comprises in particular the region created by transferring the roof or wall element into the open position. In particular, the spatial volume can correspond to this region. The spatial volume is or comprises, in particular, an additional spatial volume under the roof element or on the inside of the wall element compared to the closed position.

According to another embodiment, the space enlargement comprises a wall element. This is arranged or arrangeable on a side wall or the rear end of the recreational vehicle. The wall element can, for example, be arranged on rails, which allow the wall element to be moved outwards into the open position, in particular parallel to the wall of the recreational vehicle. In particular, the open position is used while the recreational vehicle is parked. A floor element then preferably also slides outwards. When moved into the open position, a gap is created between the wall element and the side wall or the rear end of the recreational vehicle, which is closed at the top and to the sides by the side wall so that the newly created spatial volume is protected from the weather. Preferably, the spatial volume directly extends the living space of the recreational vehicle.

In the open position, the spatial volume is delimited to the outside by at least one side wall. In the closed position, at least one side wall can be folded in, for example. The at least one side wall can be designed to be unfolded when transferred to the open position. Thus, it can be provided that the at least one side wall only functions as a side wall in the open position and/or delimits the spatial volume to the outside. Optionally, the side wall can delimit a smaller space, in particular in height, in the closed position. The space enlargement can comprise multiple side walls. Preferably, the space enlargement can comprise two, three or four side walls. In particular, the spatial volume with a roof element in the popped-up position can be circumferentially delimited to the outside by multiple side walls, in particular four side walls. The space enlargement can have one side wall on each of the front and rear sides in the direction of travel, and two side walls on the two sides. The at least one side wall may comprise one or more openings, e.g., window openings and/or ventilation openings. For a space enlargement with a wall element, the spatial volume can be delimited by two side walls on the sides and optionally by a side wall at the top.

At least in parts thereof, the at least one side wall comprises a layer of a self-expanding material. In other words, the layer of a self-expanding material can optionally be provided in regions in the at least one side wall. The layer of self-expanding material may be interrupted in parts thereof. For example, a fabric and/or another material can be provided in parts thereof. For example, an opening, in particular a window opening, may be provided. For example, a window element can be provided that can optionally be folded up towards the roof element. Preferably, the layer of self-expanding material extends at least over a large part of the at least one side wall, in particular over at least half of the area of the side wall, particularly preferably over at least 60% of the area of the at least one side wall.

A self-expanding material is generally understood to be a material that is capable of or has the property of autonomously changing its size and/or shape, in particular from a compressed state, in particular to expand itself without an external energy supply. The layer of self-expanding material is designed such that the layer is at least partially expanded in the open position. Preferably, the self-expanding material is designed such that it assumes a defined shape, in particular comprising a defined wall thickness, when the roof or wall element is in the popped-up state. Advantageously, the self-expanding material can assume a compressed state in the closed position in which it takes up little space. For example, the side walls of a pop-up roof can be advantageously arranged in the lower position between the lower shell and the roof element; optionally, they do not take up this space entirely, but still leave room for sleeping items such as pillows and blankets.

Optionally, the layer of self-expanding material can be designed in the expanded state as a stability support for the roof or wall element. Advantageously, in this case, the at least one side wall can comprise less additional material, whereby the at least one side wall can require less space, in particular in the closed position. Advantageously, the layer of self-expanding material can have heat-insulating properties. Preferably, the self-expanding material can be buckled and/or folded.

The roof or wall element and/or the at least one side wall are designed such that, when the roof or wall element is transferred from the open position to the closed position, a force acts on the self-expanding material which compresses the self-expanding material. Accordingly, the roof or wall element and/or the at least one side wall are designed in particular such that the self-expanding material is given space to expand when transferred from the closed position to the open position. The force can be transferred, for example, by a mechanism, a drive, a guide, a weight, a gear and/or a damper. Preferably, the layer of self-expanding material is designed such that it automatically compresses into a specific structure or shape under the acting force, in particular comprising a defined folding of the layer. For example, the layer may comprise appropriately designed hinges, fold lines, and/or material thinning that allow targeted or defined compression and/or folding.

According to one embodiment, the self-expanding material comprises at least one polymer system and/or at least one foam. Optionally, the self-expanding material may comprise a combination of different polymer systems and/or foams. For example, the self-expanding material may comprise polyurethane foam and/or polyether. Such materials are particularly suitable for temperature and sound insulation and are also breathable and have good compression set. Optionally, at least one polymer system and/or at least one foam can be combined with a solid wall element. A solid wall element is in particular a wall element that is not self-expanding and that is suitable as a load-bearing wall element for the roof or wall element. Optionally, at least one polymer system and/or at least one foam can be combined with a foldable element. A foldable element can in particular comprise at least two connected, in particular solid, wall elements which can be folded relative to each other.

According to one embodiment, the self-expanding material comprises shape memory polymers, in particular a foam with integrated viscoelastic polymers. Shape memory polymers are generally known in the prior art. In particular, shape memory polymers can be a memory foam. A memory foam is well suited in particular for the purpose of this invention because it returns to its original shape particularly well after compression. The memory foam can in particular comprise integrated viscoelastic polymers. Integrated viscoelastic polymers allow for a relatively slow recovery rate and thus improved contouring and adaptation to the shape of the surrounding material. This can be advantageous, for example, if in addition to the layer of self-expanding material at least one further layer, e.g., an outer shell and optionally an inner shell, is provided. The self-expanding material can then adapt particularly well to the shape given by the additional layer. The self-expanding material may comprise a mixture of shape memory polymers and other polymers. For example, the other polymers may comprise biopolymers. A biopolymer is generally a polymer that is synthesized in the cell of an animal. Depending on the specific requirements for the corresponding side wall, the composition of the mixture, in particular the proportion of different polymers, can be adapted.

According to one embodiment, the self-expanding material comprises an open-cell foam. Open-cell foam can advantageously have a particularly low weight and improved breathability. In addition, open-cell foam can enable improved moisture regulation. With an open-cell foam, an improved indoor climate can be achieved in particular in the spatial volume. The use of open-cell foam is also particularly suitable in regions where good air circulation and/or air exchange is important, for example in regions used for sleeping or cooking.

According to one embodiment, the self-expanding material comprises a biodegradable foam, in particular made from renewable raw materials. A biodegradable foam, in particular when made from renewable raw materials, is a particularly environmentally friendly alternative. Such foam is particularly suitable for applications where sustainability and environmental compatibility are paramount. For example, a biodegradable foam may also be intended for applications in which replacement of the self-expanding material and/or side walls is necessary relatively frequently compared to other applications.

According to one embodiment, the self-expanding material has one or more of the following properties:
a compression set of 0.5% to 50%, preferably 1% to 20%, particularly preferably 2% to 10%;
a density of 10 to 70, preferably 15 to 60, particularly preferably 20 to 50, kg/m^{3;}
a hardness of 1 to 10 kPa, preferably 2 to 8 kPa, more preferably 3 to 7 kPa, wherein the hardness is in particular the compression hardness;
a material thickness of 5 to 150, preferably 5 to 100, particularly preferably 10 to 80, mm.

These properties are particularly well suited to provide a stable and easily compressible side wall layer which is self-expanding at a suitable rate. An example of a material with particularly favorable properties is polyurethane foam—polyether HR30/4. Additionally or alternatively, the self-expanding material may have a Shore hardness of 10 Shore-00 to 70 Shore-A, more preferably between 5 Shore-A and 40 Shore-A. In one variant, the layer is made of self-expanding material so that, when the space enlargement is in the popped-up state, it is slightly flexible when leaned against, e.g., by a user. Advantageously, however, the layer is designed in such a way that, apart from giving way slightly when leaned against, it substantially retains its shape, in particular its wall shape. The compression set is a general measure of the material behavior during deformation, in particular compression, and subsequent release. The density and material thickness are to be seen in relation to the relaxed/unloaded or fully self-expanded material. The compression set can be measured, for example, according to DIN EN ISO 1856. The compression hardness or indentation hardness indicates the pressure at which the foam deforms by 10%.

At least one side wall can be designed in multiple layers. According to one embodiment, the side wall comprises an outer shell, and within the outer shell the self-expanding material. Preferably, the outer shell is arranged on the outside of the side wall, i.e., facing the weather conditions. The outer shell can preferably be water-repellent and/or breathable. For example, the outer shell may comprise an impregnated felt material to be water-repellent. For example, the outer shell can comprise at least one breathable membrane which is permeable to air but does not allow water in from the outside. For example, the outer shell can be glued and/or welded to the layer of self-expanding material, at least in some areas. The outer shell allows for at least a double wall. Double walls can provide improved thermal and sound insulation. In addition, an outer shell can provide protection for the layer of self-expanding material from the outside. This means that, for example, the self-expanding material can be selected more freely, as it does not need to be adapted as much to be weather-resistant. The outer shell can be designed to support the roof or wall element in the popped-up state. Advantageously, the self-expanding material itself does not have to be load-bearing. Alternatively, the roof or wall element can also be supported by other support elements in the popped-up state. Optionally, the at least one side wall may comprise an inner shell on the inside. In particular, the layer of self-expanding material can be arranged between the outer shell and the inner shell. Preferably, the inner shell is breathable. The inner shell can advantageously be designed to provide a pleasant feel and/or an advantageous appearance. In other words, by means of an inner shell, special properties of the inner wall of at least one side wall can be adjusted largely independently, without having to make technical restrictions for the layer of self-expanding material.

According to one embodiment, the space enlargement comprises an actuator, in particular a spindle drive or a pneumatic or hydraulic cylinder, with which the roof or wall element can be transferred from the closed position to the open position. For example, the space enlargement may comprise a lifting mechanism driven by the actuator, by means of which the roof or wall element can be moved from the closed position to the open position. The lifting mechanism may generally be a lifting mechanism as described herein.

The at least one side wall can be designed to be folded when the roof or wall element is transferred from the open position to the closed position. In particular, the at least one side wall can be designed so that the self-expanding material does not spread outwards when the roof or wall element is transferred from the open position to the closed position.

According to one embodiment, the at least one side wall comprises a folding aid, wherein the folding aid specifies a defined folding of the at least one side wall inward when the roof or wall element is transferred from the open position to the closed position. In particular, the folding aid can run substantially parallel to a surface of the roof or wall element. The folding aid can be provided in a center of the height range of the space enlargement. A central height range can be a height greater than 20% and less than 80%, preferably greater than 40% and less than 60%, of the total height of the space enlargement. This relative height is defined in particular with reference to the open position. The folding aid can comprise, for example, a hinge, a material thinning or recess (e.g., a groove, a notch, a milling) and/or a cord. The folding aid is in particular used to define a folding edge or fold. The defined folding may in particular comprise an inward folding. The defined folding can be defined such that the layer of self-expanding material is folded into a defined structure and/or shape inward when the roof or wall element is transferred from the open position to the closed position. Advantageously, this can prevent uncontrolled compression of the layer, so that, for example, no material protrudes laterally outwards. The space remaining under the roof or wall element in the closed position is preferably large enough to accommodate at least the folded or retracted side walls or at least one side wall. It is also advantageous to have space for additional elements, such as bedding intended for sleeping and/or additional bed elements (e.g., at least one or more pillows and at least one or more blankets).

According to one embodiment, the space enlargement comprises at least one side wall, which is folded in when the roof or wall element is transferred from the open position to the closed position, preferably without folding up. For example, a side wall of a pop-up roof can be folded up or down so that it lies flat between the lower shell and the roof element. It is conceivable to design at least one side wall so that it cannot be folded or does not have any folding aids. The adjoining side walls can in turn have folding aids. For example, when the roof element is closed, they can bend inwards at an approximately horizontal fold line. In this way, the side walls of a pop-up roof can be stored particularly space-efficiently in the closed position.

It is also conceivable that the space enlargement comprises at least one side wall which does not fold when the roof or wall element is transferred from the open position to the closed position, and at least one side wall which comprises a folding aid, wherein the folding aid specifies a defined folding of the at least one side wall inward when the roof or wall element is transferred from the open position to the closed position. The self-expanding material of the side wall with folding aid can, for example, be made of a softer material than that of the side wall without folding aid. For example, it can have a compression hardness of 0.5 to 3 kPa. In contrast, the side wall without folding aid can have a compression hardness of 3 to 9 kPa. This side wall is folded over and/or inwards, for example when the roof or wall element is transferred from the open position to the closed position, so that it lies flat against the wall or roof element.

According to one embodiment, the space enlargement comprises a plurality of side walls each adjoining one another at a corner region, each with a layer of the self-expanding material in parts thereof, wherein a material that is softer than the self-expanding material is provided in the portion of the corner region of the side walls. For example, the softer material can have a hardness of maximum 90%, preferably maximum 70%, particularly preferably maximum 50% of the hardness of the self-expanding material. For example, the softer material may have a hardness of less than 2 kPa, preferably less than 1.5 kPa, particularly preferably less than 1 kPa, wherein the hardness is in particular the compression hardness. Optionally, the softer material can also be self-expanding, but softer than that in the other regions of the side walls. Alternatively, the softer material itself may not be self-expanding. For example, the softer material can be made of a fabric or a soft foam. This can advantageously facilitate folding or collapsing of the side walls inward into the closed position. Alternatively or additionally, the layer of self-expanding material may be thinner in the portion of the corner region. The layer can comprise, for example, 10% to 70%, preferably 20% to 50% of the layer thickness. The self-expanding material can then be the same as in the other portions of the side wall. It can also be a different material, for example a softer one as just described.

A further aspect of the invention is a recreational vehicle, in particular a motorhome or camper trailer, with a space enlargement as described herein. All features, advantages and properties of the space enlargement as described herein can be transferred analogously to the recreational vehicle and vice versa. The recreational vehicle can basically be any type of recreational vehicle, comprising motorhomes, camper trailers, vans and larger cars or urban vehicles. A van can in particular be a camper van. A camper van is a transportation means that has been converted into a recreational vehicle, wherein the outer walls are in particular retained. An urban vehicle is a larger car that has been converted into a recreational vehicle using appropriate built-in elements such as a pop-up roof. The recreational vehicle may be a recreational vehicle with a living area. In particular, the recreational vehicle can be designed to facilitate overnight stays and/or living in it. However, it is not necessarily limited to that. The recreational vehicle can preferably be a motorhome or a camper trailer. A motorhome is generally a motor vehicle with an interior that is suitable or designed for living in. A camper trailer is generally a trailer for motor vehicles with an interior that is suitable or designed for living in.

Further advantages and features of the present invention will become apparent from the following description of selected exemplary embodiments with reference to the drawings. Individual features disclosed in the embodiments shown may also be used in other embodiments, unless this has been expressly excluded. The figures show the following:

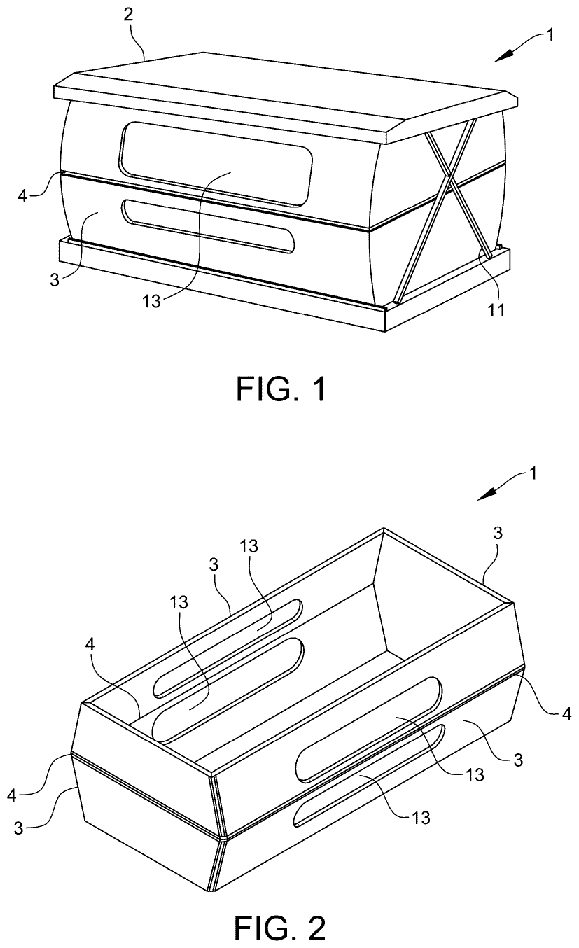

FIG. 1 shows a space enlargement in the form of an elevating roof or pop-up roof for a recreational vehicle according to an embodiment of the invention;

FIG. 2 shows a space enlargement in the form of an elevating roof or pop-up roof for a recreational vehicle according to an embodiment of the invention with a hidden roof or wall element, from a perspective view obliquely from above;

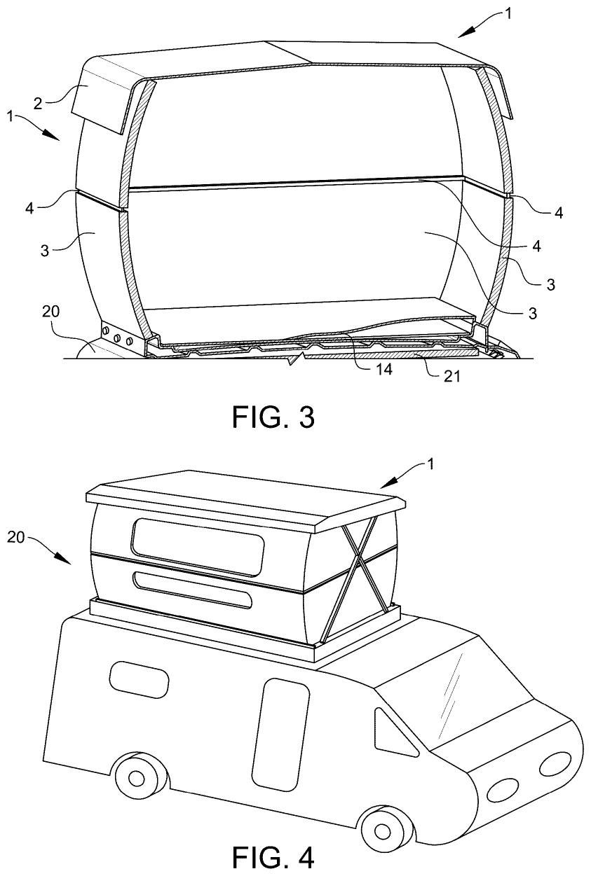

FIG. 3 shows a space enlargement in the form of an elevating roof or pop-up roof for a recreational vehicle in a sectional view according to an embodiment of the invention; and

FIG. 4 shows a recreational vehicle with a space enlargement according to an embodiment of the invention.

FIG. 1 shows a space enlargement 1 in the form of an elevating roof or pop-up roof for a recreational vehicle 20 according to an embodiment of the invention. The space enlargement 1 comprises a roof element 2 which can be arranged on a top side of a recreational vehicle 20 and is currently in an open position. In this embodiment, the space enlargement 1 further comprises four side walls 3, of which 2 can be seen here. The side walls have a layer of a self-expanding material 5, which is expanded in the open position shown here. On the outside, the side walls also have an outer shell 6, which covers the layer of self-expanding material 5 on the outside. Preferably, the outer shell 6 is water-repellent and breathable. The roof element 2 and the side walls 3 enclose a spatial volume 15 inside the space enlargement 1 and delimit it towards the outside. The spatial volume 15 can optionally be connected to an interior of the recreational vehicle 20, in particular a living space of the recreational vehicle 20.

The space enlargement 1 further comprises a lifting mechanism 11 in the form of a scissor mechanism, by means of which the roof element 2 can be moved from the closed position to the open position. The lifting mechanism 11 also serves to secure the roof element 2 in the open position. Optionally, the space enlargement 1 can comprise an actuator, for example a spindle drive or a pneumatic or hydraulic cylinder, with which the roof element 2 can be transferred from the closed position to the open position. Alternatively, a manual transfer to the open position can also be provided. If the roof element 2 is moved into the open position, the self-expanding material 5 expands independently and thus enables stable and sound-and heat-insulating side walls 3 to be present. The self-expanding material 5 comprises in particular a polymer system and/or a foam, preferably shape memory polymers or a foam with integrated viscoelastic polymers. Optionally, the self-expanding material 5 can comprise a biodegradable foam made from renewable raw materials for particularly good environmental compatibility. It is particularly advantageous if the self-expanding material 5 in the popped-up state has a density of 20 to 50 kg/m³, a hardness of 3 to 5 kPa and/or a material thickness of 10 to 80 mm. Optionally, it can be provided that a softer material is provided in the corner regions 8 of the side walls 3, which is softer than the self-expanding material 5 that is otherwise in the side walls 3. Optionally, the softer material itself can also be self-expanding.

The roof element 2 and the side walls 3 are designed such that, when the roof element 2 is transferred from the open position to the closed position, a force acts on the self-expanding material 5, which compresses the self-expanding material 5. In particular, when the roof element 2 is pulled down, it presses on the self-expanding material 5 and thus leads to its compression. The side walls 3 have folding aids 4 which run substantially parallel to a surface of the roof element 2. When the roof element 2 is transferred from the open position to the closed position, the folding aids 4 provide a defined folding of the side walls 4 inward so that they fold inwards. For this purpose, the folding aids 4 comprise circumferential grooves in the side walls 3 as well as correspondingly designed hinges (not explicitly shown here). The roof element 2 can be pulled down automatically or manually. For example, the roof element 2 can comprise a corresponding grip element, e.g., a handle or a cord, with which it can be pulled down. Two of the side walls 3 (the side wall 3 at the front in the image and the opposite side wall 3 not visible here) also have window openings 13.

FIG. 2 shows a space enlargement 1 in the form of an elevating roof or pop-up roof for a recreational vehicle 20 according to an embodiment of the invention with the roof element 2 hidden, from a perspective view obliquely from above. This embodiment may otherwise correspond to that of FIG. 1. In this embodiment, too, a lifting mechanism 11 can optionally be provided, although this is not shown here. By hiding the roof element 2, a view of the spatial volume 15 is provided, which is laterally delimited by the side walls 4.

FIG. 3 shows a space enlargement 1 in the form of an elevating roof or pop-up roof for a recreational vehicle 20, in a sectional view according to an embodiment of the invention. The section of the image allows a view into the spatial volume 15 from the front. The space enlargement 1 comprises a roof element 2, which is arranged on a top side of a recreational vehicle 20 and is currently in an open position. In this embodiment, the space enlargement 1 also comprises a lower shell 14, which is arranged on a roof 21 of the recreational vehicle 20. Under the roof 21 of the recreational vehicle 20 there is an interior space, in particular a living area, of the recreational vehicle 20. Also visible in the section is the self-expanding material 5, which in this embodiment is arranged between an outer shell 6 and an inner shell 7. Preferably, the outer shell 6 and the inner shell 7 are designed to be breathable. The inner shell 7 can, for example, be advantageously adapted with regard to its feel and appearance. The outer shell 6 can, for example, be designed to protect the self-expanding material 5 from environmental influences. For example, the outer shell can be made water-repellent. The horizontally running folding aids 4 of the side walls 3 can be seen here from the inside and outside. The folding aids 4 can in particular comprise grooves and hinges.

FIG. 4 shows a recreational vehicle 20 with a space enlargement 1 according to an embodiment of the invention. The space enlargement 1 corresponds to the space enlargement 1 as shown in FIG. 1 and described with reference thereto. The recreational vehicle 20 in this embodiment is a motorhome, but can basically be any type of recreational vehicle 20, in addition to motorhomes, also, for example, a camper trailer, a van or a larger car or an urban vehicle. The space enlargement 1 is arranged on the top side of the motorhome of the motorhome. Optionally, the spatial volume 15 of the space enlargement 1 is connected to an interior space, namely a living area, of the motorhome.

### LIST OF REFERENCE SIGNS

1—space enlargement
2—roof element
3—side wall
4—folding aid
5—self-expanding material
6—outer shell
7—inner shell
8—corner region
11—lifting mechanism
13—window opening
14—lower shell
15—spatial volume
20—recreational vehicle
21—roof of the recreational vehicle

1. A space enlargement, in particular pop-up roof or elevating roof, for a recreational vehicle, comprising:
a roof element which is arranged or arrangeable on a roof or wall of a recreational vehicle and can be transferred from a closed position to an open position, wherein in the open position a spatial volume is formed on the inside of the roof element of the recreational vehicle, which is or can be connected in particular to an interior of the recreational vehicle,
at least one side wall which delimits the spatial volume to the outside in the open position, wherein the at least one side wall has at least in parts thereof a layer of a self-expanding material which is at least partially expanded in the open position,
wherein the roof element and/or the at least one side wall are designed such that, when the roof element is transferred from the open position to the closed position, a force acts on the self-expanding material which compresses the self-expanding material.

2. The space enlargement according to claim 1,
wherein the roof element is a roof element which is arranged or arrangeable on a top side of the recreational vehicle and can be transferred from a lower, closed position to a popped-up, open position, or
wherein the roof element is a wall element which is arranged or arrangeable on a side or a rear end of the recreational vehicle.

3. The space enlargement according to claim 1,
wherein the self-expanding material comprises at least one polymer system and/or at least one foam, in particular a biodegradable foam made from renewable raw materials.

4. The space enlargement according to claim 1,
wherein the self-expanding material comprises self-expanding material shape memory polymers, in particular a foam with integrated viscoelastic polymers.

5. The space enlargement according to claim 1,
wherein the self-expanding material has one or more of the following properties:
a compression set of 0.5% to 50%, preferably 1% to 20%, particularly preferably 2% to 10%;
a density of 10 kg/m³ to 70 kg/m³, preferably 15 kg/m³ to 60 kg/m³, particularly preferably 20 kg/m³ to 50 kg/m³;
a hardness of 1 kPa to 10 kPa, preferably 2 kPa to 8 kPa, particularly preferably 3 kPa to 7 kPa; and
a material thickness of 5 mm to 150 mm, preferably 5 mm to 100 mm, particularly preferably 10 mm to 80 mm.

6. The space enlargement according to claim 1,
wherein the at least one side wall comprises an outer shell, in particular a water-repellent and/or breathable one, and comprises the self-expanding material within the outer shell.

7. The space enlargement according to claim 1,
wherein the space enlargement comprises an actuator, in particular a spindle drive or a pneumatic or hydraulic cylinder, with which the roof element can be transferred from the closed position to the open position.

8. The space enlargement according to claim 1,
wherein the at least one side wall comprises a folding aid which in particular runs substantially parallel to a surface of the roof element, wherein the folding aid specifies a defined folding of the at least one side wall inward when the roof element is transferred from the open position to the closed position.

9. The space enlargement according to claim 1,
wherein the space enlargement comprises a plurality of side walls each adjoining one another at a corner region, each with a layer of the self-expanding material in parts thereof,
wherein a softer or thinner material than the self-expanding material is provided in the portion of the corner region of the side walls.

10. A recreational vehicle, in particular a motorhome or camper trailer, having a space enlargement according to claim 1.
